(19) United States
(12) Patent Application Publication
(10) Pub. No.: US 2003/0228561 A1
(43) Pub. Date: Dec. 11, 2003

(54) Repetitive learning system and method

(76) Inventor: Adrian Roland Escalante, Pleasant Grove, UT (US)

Correspondence Address: David R. McKinney, THORPE, NORTH & WESTERN, L.L.P., P.O. Box 1219, Sandy, UT, 84091-1219, US

(21) Appl. No.: 10/171,195

(22) Filed: Jun. 11, 2002

(51) Int. Cl. G09B 19/00

(52) U.S. Cl. 434/219; 434/362; 434/322

(57) ABSTRACT

A system and method for providing task-specific training to a worker engaged in a job includes the steps of observing a worker engaged in at least one job-related task, and identifying skills required by the worker. A series of brief lessons are configured to teach at least one of the identified skills, and to require repetitious practice of the skill. The worker is provided with the lessons, which may be self-administered, on a repetitive basis during standard workdays, and is caused to interact with another worker while receiving the lessons. A time interval is provided between lessons to allow the worker to practice the skills on the job. The invention is particularly adapted for teaching performance-based skills, and can be applied to any knowledge or skills that are best developed with a high degree of repetition in short intervals over time.

### BACKGROUND OF THE INVENTION

1. Field of the Invention

The present invention relates generally to methods for gaining knowledge or skills over time. More particularly, the present invention relates to a system for providing performance-based task-specific training or education in short bursts spaced over regular time intervals.

2. Related Art

Educational and instructional methods have been around as long as man. Wherever there is information to convey or skills to teach, people have developed methods for accomplishing this task. However, the various teaching methods have varying degrees of effectiveness. There are a wide variety of methods for presenting information and teaching skills, including job-related skills.

The most common methods of instruction usually involve a teacher presenting information, frequently in a lecture format in a classroom setting, then assigning reading, exercises, or other “homework” for the learners to complete outside of the classroom before the next lecture session. The “homework” may involve merely reviewing information, or may include practicing tasks or skills learned, whether it be mathematics problems or foreign language skills. Unfortunately, the traditional method of instruction typically provides too much information in a single dose, and does not work effectively for all types of learners.

In the employment arena, cost and economic issues frequently influence the type of teaching methods employed. Where employers desire to have their employees learn new job skills or information, they often require the employees to attend a seminar of one kind or another, frequently at a location off the job site. In such situations, the employees typically receive classroom-type instruction ranging in duration from a few hours to several days, then return to their job. Unfortunately, it is very difficult for the employees to retain and implement the large volume of information received in the seminar. There is just too much information, and because it is not received in the job setting itself, it becomes difficult for the employee to connect the information to their job practices and habits. Consequently, employers are often frustrated that their employees do not seem to be retaining or implementing the skills that are being taught, or are simply forgetting what they have learned.

Education specialists have known for a long time that retention of information is fostered by repetition and by practice. Moreover, learners are better able to receive, practice, and retain information and skills when these are presented in small doses that are spaced out at regular intervals of time. This is what is known as spaced learning. With spaced learning, the learners receive a relatively small amount of information or training, and then are given a time interval to practice skills or review the information.

Additionally, there are many different types of learners. Some people are visual learners, and are more likely to remember information when presented with an image of some kind. Others are audible learners, and need to hear information in order to retain it. Still others are tactile learners. These people retain information best when it is associated with tactile memory, such as an action, a gesture, or a motion of some kind. Furthermore, all types of learners are better able to retain information when it is received in the situation in which it will be used, and where the learning is coupled with doing something.

### SUMMARY OF THE INVENTION

It has been recognized that it would be advantageous to develop a learning system that provides job-specific training and information to workers using a spaced learning method in short bursts over a period of time, and requires the workers to use the skills and information on the job.

It would also be advantageous to have a learning system that is adaptable to the various types of learning types, and includes resources for visual, auditory, and tactile learners.

It would also be advantageous to have such a learning system that is self-administered.

The invention advantageously provides a method for providing task-specific training to a worker engaged in a job. The method includes the steps of (a) observing a worker engaged in at least one job-related task; (b) identifying skills required by the worker engaged in the at least one job-related task; (c) preparing a series of lessons, each lesson configured to teach at least one of the identified skills to the worker, and to require repetitious practice of the skill; (d) causing the worker to receive at least a portion of the series of lessons on a repetitive basis during standard work days, and to interact with at least one other worker while receiving the lesson; and (e) providing a time interval between lessons to allow the worker to practice the at least one skill while engaged in the job.

In accordance with a more detailed aspect of the present invention, the invention provides a method of learning, including the steps of: (a) receiving information through a first self-administered lesson; (b) performing tasks requiring application of the information during a time interval following the brief lesson; and (c) receiving a subsequent brief self-administered lesson after the time interval.

In accordance with another more detailed aspect of the present invention, the invention provides a system for teaching task-specific skills, comprising a plurality of brief lessons, relating to skills required by tasks performed by a learner; and a flexible schedule for self-administration of each of the lessons in the series by the learner, the schedule allowing self-administration of the lessons at spaced time intervals selected by the learner; and a series of task assignments associated with each lesson, designed to allow the learner to practice the skills taught in the associated lesson.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

FIG. 1 is a block diagram showing the steps involved in one embodiment of an instructional method in accordance with the present invention.

FIG. 2 is a block diagram showing the steps involved in an alternative embodiment of the present invention wherein the instructional content is received via a computer network.

### DETAILED DESCRIPTION

Reference will now be made to exemplary embodiments of the invention, including those illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

The present invention provides a method for providing task-specific training, such as to workers engaged in a job. Language training is one area of particular need for this invention. The latest statistics show that there has been a huge increase in non-English speaking workers in the United States in recent years. According to the 2000 Census, 44% of all immigrants now living in the United States, some 13.3 million people, arrived during the 1990's. This count does not include illegal immigrants, who increase those numbers even more.

These immigrants typically need jobs. However, to adequately perform even relatively simple entry-level jobs, they need at least a basic level of English language proficiency. The challenge is that most need a job to afford language training, but cannot get a job until after they have the language training. Some companies are willing to pay for some basic English language training for their workers. However, these companies also need the workers to perform on the job from the beginning. The present invention advantageously provides a system or method that allows workers to receive the needed language training while on the job, but does not take significant time away from the job.

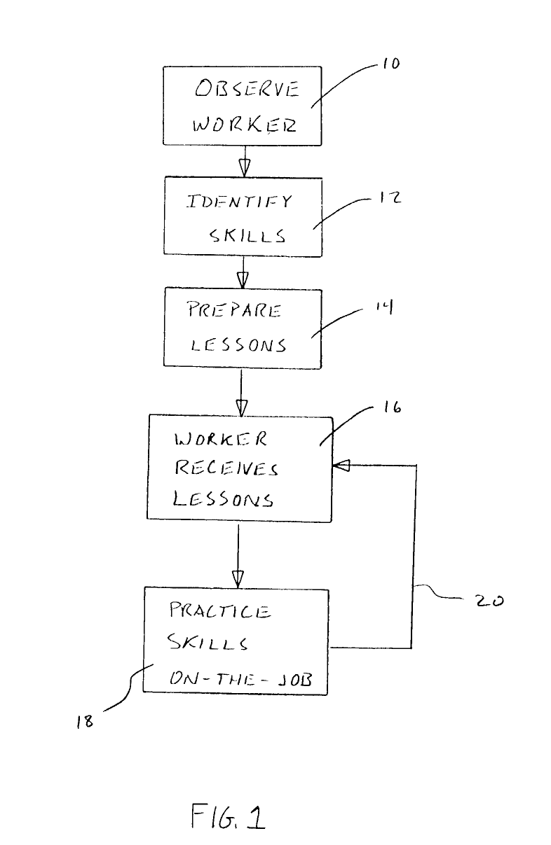

Viewing FIG. 1, in one embodiment of the method of the present invention, the first steps involve observing a worker engaged in a job-related task (step 10), and identifying skills required by the worker in that job (step 12). Such skills may include communication skills, supervisory skills, sales skills, human resource management skills, problem solving skills, and any other types of performance-related skills. For example, a person identifying language skills required by workers in a particular job may record conversations between skilled workers and customers. These conversations then provide the basis for determining what communication skills are needed by employees in that particular job.

Based on the identification of skills required by the worker, a series of lessons are prepared (step 14), each lesson designed to teach at least one of the identified skills to the worker, and to require repetitious practice of the skill. These lessons are preferably very brief. For example, the lessons are preferably less than 30 minutes in length, and more preferably about 10 minutes in length. This sort of system is desirable to employers because it does not take substantial time away from the worker's regular duties. However, it is also beneficial to learners because it provides a quantity of information that can be easily absorbed and quickly applied.

To put the system into practice, the series of lessons are presented to the worker (step 16) on a repetitive basis during standard workdays, and preferably at the place of work. The lesson may be presented substantially verbally, such as for teaching communication skills. However, the lesson may be presented in others ways. The lessons could be presented electronically via email or over the Internet. For example, lessons may be provided over a computer terminal to a worker at a call center during one of the frequent intervals of down time. Alternatively, daily lessons may arrive at a worker's computer terminal via e-mail. The lesson may require feedback from the worker through the computer terminal, to indicate that the lesson has been received, or to demonstrate substantive understanding of the lesson content.

In one embodiment of the invention, the worker is caused to interact with at least one other worker while receiving the lesson. One way to do this is through a “huddle” approach. A group of workers gather together at the beginning of the work day, and together go over the material for the day's lesson. This allows workers to facilitate the learning of each other, and provides audio, visual, and tactile reinforcement of the information learned. Moreover, because the information is received at the place of work, the worker is more likely to recall it because they work in the same environment, rather than learning in a classroom and working elsewhere.

In one embodiment, the lessons are self-administered by the workers. That is, the lesson material is provided to the workers, and they review the material together, without the need for a teacher. A facilitator may also be provided to promote interaction between workers. The facilitator is not a teacher, but rather a person whose task is to help the other workers grasp and apply the lesson material. In the case of language instruction, for example, the facilitator may simply be another worker who speaks the language. The facilitator helps provide or promote visual, auditory, and tactile stimulation for the various workers who may need those different types of input in order to retain the lesson content. The system may also be augmented with resources for each of the various types of learners. For visual learners, the lesson may be provided in the form of a workbook. For auditory learners, an audio CD containing the lesson may be made available. For tactile learners, their lesson may include the requirement to say something, or to make a gesture or motion.

Following each lesson, a time interval is provided between lessons to allow the worker to practice the at least one skill while engaged in the job (step 18). For example, in one embodiment the lessons may be repeated (designated by arrow 20) on a substantially daily scheme, with a time interval of about one day between lessons. This provides a series of short bursts of learning, followed by a period for practicing and internalizing the information or skills that have been learned.

The lessons may be designed to be received in a defined sequence, and some of the lessons may build upon the subject matter of a previous lesson. Alternatively, the lessons may be designed to be received in no particular sequence. The advantage of non-sequential lessons is that a worker can be brought into the program at any time, without having missed anything essential for continuation. Another advantageous aspect of the present method is that it can be personalized to the individual needs of a worker. For example, before instituting the system with a group of workers, each individual may be tested to determine their current level of understanding or skill in the particular area. Then, the lesson provided to each worker may differ according to the individual worker's skills or understanding. Interaction between workers is still possible because workers with differing levels of proficiency can still provide feedback to each other or play the role of a customer or other worker.

Viewing the invention from the opposite viewpoint, the invention provides a method of learning through the steps of receiving information through a self-administered lesson, performing tasks requiring application of the information during a time interval following the lesson, and receiving a subsequent self-administered lesson after the time interval.

Alternatively, the invention can be viewed as a system for teaching task-specific skills. The system includes a series of brief lessons, relating to skills required by tasks performed by a learner, and a flexible schedule for self-administration of each of the lessons in the series by the learner. The schedule preferably allows administration of the lessons at spaced time intervals selected by the learner. Along with the series of lessons are a series of task assignments associated with each lesson, designed to allow the learner to practice the skills taught in the associated lesson. As noted above, a facilitator may be used with the system for assisting the learner in self-administration of the lessons. Likewise, the lessons are brief, being less than about 30 minutes in length and more preferably about 10 minutes long, and are spaced at time intervals of about one day.

Some operative examples may help to illustrate the invention. Among the large immigrant worker population discussed above, it is estimated that about 4 million immigrants currently work in the hospitality industry (i.e. hotels and restaurants). This industry has a great need for rapid language training of workers to give them the most basic and essential skills for their job. In a hotel, for example, non-English speaking immigrants may fill jobs in food service and housekeeping. Upon instituting the system, the employer may test each worker, verbally and/or in writing, to determine their level of English language skill. In one application of the invention, each worker then receives a separate set of instructional materials that relate to their skill level and job classification. For example, food service workers need different skills than housekeeping, so members of these different groups will receive different training materials. Likewise, the instructional materials may vary depending upon the individual learner type, as described above.

When the workers arrive each morning, they initially gather in small groups or “huddles” based upon their job classification. In the “huddles” the workers each take turns repeating the contents of their lesson for that day, interacting with each other in various ways, such as by role-playing (e.g. customer and worker), quizzing, etc. For example, considering the food service workers, in a particular days' language huddle, one food service worker who is a waiter and already has some English skills may be learning a short series of phrases related to taking a customer's order. Another who is a cook and possesses relatively limited English skills may be learning the names of various cuts of meat. The cook can pretend to be a customer, allowing the waiter to practice his phrases, then the waiter can quiz the cook on the cuts of meat. Alternatively, a facilitator who is also in the huddle can take on these roles for each worker in turn. This huddle lasts for about 10 minutes, after which the workers go about their daily routine. However, during the work day, the workers are each required to use the phrases they practiced in the huddle. For example, the waiter may take the order of a customer using the new phrases learned, and the cook may ask his supervisor a question about each of the cuts of meat.

The following day, the workers gather in the huddle again, and take the next lesson. This lesson may build upon the one before, or may be completely independent of it. It may also include a review of the previous day's material, or may simply begin the new material. However, the general process and time frame is the same. This day, the waiter may learn phrases associated with a customer's bill, while the cook learns verbs for different cooking processes (e.g. boil, fry, simmer, etc.). After the huddle, the workers again go about their ordinary work duties, practicing the new skills they have learned. In this way, the information is repeated and given an experiential context, making it far more memorable. Consequently, the workers learn the information and skills faster and retain them longer.

The same system is applicable to the housekeeping staff. On one day, in the huddle a worker may learn and repeat phrases needed for basic interaction with guests at the hotel, then practice those phrases with guests throughout the day. The next day, the worker may cover phrases related to the condition of a room, then practice those phrases with a supervisor throughout the day. On a third day, the same worker may learn and practice phrases related to different cleaning operations. Following this procedure, the worker gains incremental skills in spaced intervals, and retains the skills by repetition in the work environment.

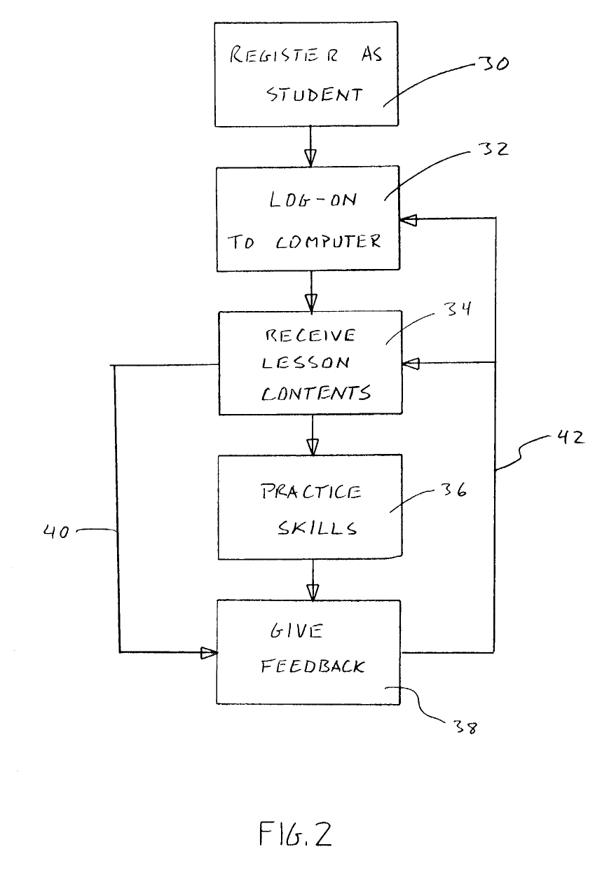

In another embodiment, depicted generally in FIG. 2, the system may be implemented through computer-delivered communications, such as e-mail. In this embodiment of the system, a user first becomes registered as a student for an instructional course (step 30), having a computer interconnected to a computer network (such as the Internet, a LAN, etc.). The user then receives, on a regular basis, brief instructional lessons via the computer (step 34), such as through e-mail or the like. The lessons provided in this way may include graphics, audio, or other multimedia content that can be delivered via computer. The lessons prompt the user to practice the skill that is taught (step 36), and then require feedback at the end of the user's practice (step 38). Depending on the content of the lesson, the step of practicing the skills (step 36) may at times be skipped, as indicated by arrow 40.

The requested feedback may merely provide an indication to the computer system that the student has completed the day's lesson. Alternatively the feedback could involve a quiz to review the lesson content, ask questions about the results of the student's practice (e.g. “when you said ‘may I help you?’ to a listener, what was their response?), or solicit comments about the lesson from the student to enable modifications for greater effectiveness. Other types of feedback could also be requested. The system may be designed to use this feedback to prompt a response. For example, the answers to quiz questions may indicate that the student has mastered certain skills and can skip certain subsequent lessons. On the other hand, the feedback could indicate that additional instruction in that particular topic is needed, and selected remedial lessons may be provided. The computer software can make these determinations, and select subsequent lessons for the individual student's needs.

After giving the required feedback, the system waits a time interval and then presents another lesson, as indicated by arrow 42. As indicated by arrow 42, the subsequent lesson may not occur until after the student has logged-on again (step 32), or may proceed before a subsequent log-in (step 34). Advantageously, because the lessons are provided by computer, they are interactive, and the computer to a very large extent performs the functions of a human facilitator discussed above.

This embodiment of the system is particularly useful for training workers in call centers, where each worker has a computer terminal interconnected to a local network, and there are frequent intervals of “down” time when a given worker may have no calls to take. When a worker logs-in to their computer on a given day, the computer starts the day's lesson and provides the content at the first appropriate time. The lesson prompts the worker to briefly practice the skill that was taught in the lesson, then to provide feedback related to the lesson and/or the practice. The user's responses confirm that the lesson content has been received, and may stimulate a response from the computer, such as suggestions for future practice, positive encouragement, etc.

Alternatively, the lessons may be delivered via the Internet. Following registration of a person for a course, the person's computer becomes linked to a website which periodically sends the lesson via e-mail, prompts the user to practice, and then requests feedback.

The system can be augmented with a certification program. For example, in language instruction, workers may initially be tested for their proficiency in the target language according to a standard testing system. Their proficiency is then rated, such as according to a scale of 1 to 5, with 5 being the highest level, and a certification of the worker's skill is given to the worker. Then, when the worker has completed additional instruction and/or retaken the proficiency test, their certification may be revised. This certification system will preferably be widely recognized, so that if the worker seeks employment with another employer, he can simply report that he is “certified Level 4 in English.” The employer would immediately know what that means, and have a standard measuring tool for comparing prospective employees' skills.

The present invention advantageously provides a system that is adapted for teaching performance-based skills to learners, and is particularly useful for job training. It can be applied to any knowledge or skills that are best developed over time with a high degree of repetition in short intervals. Any information that benefits from regular and frequent exposure on a short-term basis is suitable for this method. It is particularly adaptable to skill-based applications. It is intended to be performance-based, with the goal of modifying the behavior of workers or others. Because it uses a relatively small amount of time, it is very adaptable to the economics of the workplace. Because it is interactive and accommodates different learning styles, the information is more likely to be retained and the skills actually developed. Moreover, because the system operates in an application mode rather than a study mode, many learners who are intimidated by the classroom environment will be more apt to give full effort, and all learners are more likely to retain the skills and information learned.

It is to be understood that the above-referenced arrangements are only illustrative of the application for the principles of the present invention. Numerous modifications and alternative arrangements can be devised without departing from the spirit and scope of the present invention while the present invention has been shown in the drawings and fully described above with particularity and detail in connection with what is presently deemed to be the most practical and preferred embodiments(s) of the invention, it will be apparent to those of ordinary skill in the art that numerous modifications can be made without departing from the principles and concepts of the invention as set forth in the claims.

What is claimed is:

1. A method for providing task-specific training to a worker engaged in a job, comprising the steps of:
a) observing a worker within a predetermined job classification engaged in at least one job-related task;
b) identifying skills required for the worker engaged in the at least one job-related task;
c) preparing a series of lessons, each of less than 30 minutes duration, each lesson configured to teach at least one of the identified skills, and to require repetitious practice of the skill;
d) presenting at least a portion of the series of lessons to workers within the job classification on a repetitive basis during standard work days, and causing the workers to interact while receiving the lesson; and
e) providing a time interval between lessons to allow the workers to practice the at least one skill while engaged in the job.

2. A method in accordance with claim 1, wherein the series of lessons are repeated on a substantially daily scheme.

3. A method in accordance with claim 1, wherein each of the series of lessons are about 10 minutes in length.

4. A method in accordance with claim 1, wherein the time interval is at least about one day.

5. A method in accordance with claim 1, further comprising the step of providing a facilitator to promote interaction between workers.

6. A method in accordance with claim 1, wherein the lessons are designed to be received in a defined sequence.

7. A method in accordance with claim 1, wherein the lessons are designed to be received in no particular sequence.

8. A method in accordance with claim 1, wherein the lesson is presented via a computer network.

9. A method in accordance with claim 8, wherein the lesson is presented via e-mail.

10. A method in accordance with claim 1, wherein the skills required by the at least one task are selected from the group consisting of communication skills, supervisory skills, sales skills, human resource management skills, problem solving skills.

11. A method in accordance with claim 10, wherein the lesson is presented substantially verbally.

12. A method of teaching job-related skills to a group of workers engaged in jobs that are part of a common job classification, comprising the steps of:
a) identifying job-related skills common to the group of workers;
b) presenting a lesson of less than 30 minutes duration to at least one of the group of workers while on the job, the lesson configured to teach at least one of the job-related skills, and to require repetitious practice of the skill on the job;
c) providing a time interval following the lesson to allow the worker to practice the at least one skill while engaged in job activities;
d) receiving feedback from the worker related to the lesson; and
e) presenting a subsequent lesson after the time interval.

13. A method in accordance with claim 12, wherein the subject matter of the subsequent lesson builds upon the subject matter of the first lesson.

14. A method in accordance with claim 12, wherein the tasks performed during the time interval following the lesson are selected from the group consisting of communication tasks, supervisory tasks, sales tasks, human resource management tasks, and problem-solving tasks.

15. A method in accordance with claim 12, further comprising the step of repeating steps (a) through (e) to teach additional job-related skills.

16. A method in accordance with claim 12, wherein the step of presenting a lesson comprises the specific step of communicating lesson material via an Internet connection.

17. A system for teaching task-specific skills, comprising:
a) a plurality of brief lessons, each of less than 30 minutes duration, specifically composed for and related to skills required by workers within a common job classification at a job location;
b) an instruction schedule for self-administration of each of the lessons in the series by the workers, the schedule requiring administration of the lessons at the worker's job location at spaced time intervals;
c) a task assignment associated with each lesson, designed to allow the workers to practice the skills taught in the associated lesson at the job location during the time interval following each lesson; and
d) a feedback mechanism for receiving lesson-related feedback from the workers.

18. A system in accordance with claim 17, further comprising a facilitator for assisting the workers in self-administration of the lessons.

19. A system in accordance with claim 17, wherein self-administration of the lessons requires interaction between a plurality of workers receiving the lessons.

20. A system in accordance with claim 17, wherein the plurality of lessons are less than about 30 minutes in length, and the spaced time intervals are about one day.

21. A system in accordance with claim 17, further comprising learning resources selected from the group consisting of a workbook, an audio broadcast, computer graphics, a requirement to perform a physical action, and a requirement to provide feedback to a computer system.
